(19) United States
(12) Patent Application Publication
(10) Pub. No.: US 2024/0390209 A1
(43) Pub. Date: Nov. 28, 2024

(54) Exoskeletal Upper Limb Rehabilitation Device

(71) Applicant: UNIVERSITY OF MANITOBA, Winnipeg (CA)

(72) Inventors: Qingjin Peng, Winnipeg (CA); Yanlin Shi, Winnipeg (CA)

(21) Appl. No.: 18/693,233

(22) PCT Filed: Dec. 7, 2022
(86) PCT No.: PCT/CA2022/051781

§ 371 Date: Mar. 19, 2024

Related U.S. Application Data
(60) Provisional application No. 63/287,167, filed on Dec. 8, 2021.

(51) Int. Cl. A61H 1/02

(52) U.S. Cl. CPC A61H 1/0285; A61H 1/0277; A61H 2201/0138; A61H 2201/0157; A61H 2201/0192; A61H 2201/1215; A61H 2201/1436; A61H 2201/1614; A61H 2201/165

(57) ABSTRACT

An exoskeletal rehabilitation device supports a hand, a lower arm portion, and an upper arm portion of a user relative to a supporting surface for rehabilitating the arm. The device has a shoulder frame that pivots about a first shoulder axis relative to a base frame fixed onto the supporting surface. An upper arm frame alongside the upper arm portion pivots on the shoulder frame about a second shoulder axis transverse to the first. A lower arm frame alongside the lower arm portion pivots on the upper arm frame about an upright elbow axis. A wrist frame supports a handle frame that receives the hand relative to the lower arm frame. The wrist frame pivots on the lower arm frame about a longitudinal axis longitudinal of the lower arm portion, while the handle frame pivots on the wrist frame about a wrist axis for flexion and extension of the hand.

### FIELD OF THE INVENTION

The present invention relates to an exoskeletal rehabilitation device arranged to be supported alongside an upper limb of a patient to support and/or guide movement of the upper limb of the patient during rehabilitation to recover injured arms.

### BACKGROUND

Many patents and products of upper limb rehabilitation devices are available in the market. There are two kinds of upper limb rehabilitation devices including end-effector-based rehabilitation devices and exoskeleton-based rehabilitation devices. End-effector-based rehabilitation devices are connected to patients at one distal point, and joints of the rehabilitation device do not contact with human joints. Exoskeleton-based rehabilitation devices resemble human limbs and joint axes to contact the patient.

Existing end-effector-based rehabilitation devices cannot meet the requirement of adaptability in rehabilitation. There is only one joint of the device connected to the upper arm of the patient, movement angles for elbows and shoulders cannot be controlled in the rehabilitation exercise. The device cannot be adjusted in length based on patient arms. It cannot guide patients to recovery injury arms step by step, especially for seriously injured patients. In addition, inaccurate movement angles may also cause further injury of patients in the exercise.

One example of an existing end-effector-based rehabilitation device is commercialized under the name Icone® by Heaxel (www.heaxel.com), an Italian company based in Rome. The Icone® device cannot adjust length of the rehabilitation arm and control movement angles accurately. Although it can be used at home, it cannot guide patients to complete rehabilitation exercise accurately.

Existing exoskeleton-based rehabilitation devices are not portable as their large size, which restricts application locations of the devices. In addition, arms' lengths and heights of these devices are fixed. Patients only can use the device in clinics rather than at home.

One example of an existing exoskeleton-based rehabilitation device is commercialized under the name Armeo® Spring by Hocoma AG (www.hocoma.com) in Switzerland. The Armeo® Spring device is large and accordingly not well suited to portability such that it must typically be used in a commercial environment. Furthermore, the mechanism uses a guide and slider in supporting the rehabilitation arm, which increases the size of the device. The adjustment mechanism of the device uses a guide for adjusting height of the rehabilitation arm, which requires a large base to keep balance of the device. In addition, the rehabilitation arm of the device is fixed with the height adjustment mechanism, which cannot be folded for the portable need.

### SUMMARY OF THE INVENTION

According to one aspect of the present invention there is provided an exoskeletal rehabilitation device arranged to support a hand, a lower arm portion, and an upper arm portion of an arm of a user relative to a supporting surface for rehabilitating the arm of the user, the device comprising:
a base frame arranged to be mounted in fixed relation to the supporting surface;
a shoulder frame coupled to the base frame for pivotal movement about a first shoulder axis;
an upper arm frame coupled to the shoulder frame for pivotal movement about a second shoulder axis transverse to the first shoulder axis relative to the shoulder frame, the upper arm frame being arranged to extend alongside the upper arm portion of the arm of the user when the arm of the user is supported on the device such that (i) pivotal movement of the upper arm frame about the second shoulder axis corresponds to abduction and adduction of the upper arm portion of the arm of the user, and (ii) pivotal movement of the shoulder frame portion about the first shoulder axis corresponds to flexion and extension of the upper arm portion of the arm of the user;
a lower arm frame coupled to the upper arm frame for pivotal movement about an upright elbow axis relative to the upper arm frame, the lower arm frame being arranged to extend alongside the lower arm portion of the arm of the user when the arm of the user is supported on the device such that pivotal movement of the lower arm frame about the upright elbow axis corresponds to flexion and extension of the lower arm portion of the arm of the user;
a wrist frame coupled to the lower arm frame for pivotal movement about a longitudinal axis of the lower arm frame relative to the lower arm frame such that pivotal movement of the wrist frame about the longitudinal axis corresponds to pronation and supination of the lower arm portion of the arm of the user; and
a handle frame coupled to the lower arm frame for pivotal movement about a wrist axis relative to the wrist frame, the handle frame defining a handle thereon arranged to be gripped in the hand of the user when the arm of the user is supported on the device such that pivotal movement of the handle frame about the wrist axis relative to the wrist frame corresponds to flexion and extension of the hand of the user.

The upper limb exoskeleton rehabilitation device is designed for adaptability and portability. The upper limb rehabilitation device aids patients to recover injured arms. It can reduce work of the therapist during the rehabilitation process. The device simulates the skeletal structure of the patient limb to guide patients moving arm. It is commonly used in the rehabilitation process. This device improves problems of the existing rehabilitation devices in adaptability and portability to meet different patient requirements. It has 5 degrees of freedom (DOF) including shoulder abduction/adduction, shoulder flexion/extension, elbow flexion/extension, forearm pronation/supination, and wrist flexion/extension.

The device provides a large adjustable range to meet patients with different arm lengths and heights. By a first adjustment on the base frame, the device height can be adjusted to meet patients with different heights. A supporting ring that receives the upper arm of the user therethrough can also be adjusted or replaced with different ring diameters to hold different patient arms. By adjusting a length of the upper arm frame, the length between shoulder and elbow is adjusted for patients with different arm lengths.

Furthermore, the device is highly portable by the detachable structure of the base frame. The device is easily installed by a screw clamp onto various supporting structures to reduce the device size significantly. A universal wheel further supports a portion of the device for rolling movement along the upper surface of a table or counter for stable operations relative to the supporting structure.

The device may be further arranged such that the base frame includes a mounting portion arranged to be secured to the supporting surface at a location in proximity to the first and second shoulder axes.

When provided in combination with a counter defining the supporting surface thereon, the base frame is preferably supported in fixed and immovable relationship to the counter.

The base frame may include a clamp member arranged to be clamped onto an object defining the supporting surface thereon in which the clamp member is located in proximity to the first and second shoulder axes of the device.

Preferably the base frame is adjustable in height relative to the clamp member.

The device may further include (i) a mounting portion on the base frame arranged to secure the base frame fixed and immovably to the supporting surface, and (ii) a secondary supporting portion on the shoulder frame arranged to engage the supporting surface and support the shoulder frame for movement relative to the supporting surface while the shoulder frame is displaced about the first shoulder axis relative to the base frame. Preferably the secondary supporting portion includes a roller arranged to be supported in rolling contact with the supporting surface while the shoulder frame is displaced about the first shoulder axis relative to the base frame.

The device may further comprise: (i) a first shoulder motor operatively connected between the shoulder frame and the base frame to assist in driving movement of the shoulder frame relative to the base frame about the first shoulder axis; (ii) a second shoulder motor operatively connected between the upper arm frame and the shoulder frame to assist in driving movement of the upper arm frame relative to the shoulder frame about the second shoulder axis; (iii) an elbow motor operatively connected between the lower arm frame and the upper arm frame to assist in driving movement of the lower arm frame relative to the upper arm frame about the upright elbow axis; (iv) a lower arm motor operatively connected between the wrist frame and the lower arm frame to assist in driving movement of the wrist frame relative to the lower arm frame about the longitudinal axis of the lower arm frame; and (v) a wrist motor operatively connected between the handle frame and the wrist frame to assist in driving movement of the handle frame relative to the wrist frame about the wrist axis.

Preferably each of the motors comprises a rotary driven motor having a rotary output.

The device may further comprise: (i) a sliding member supported for linear sliding movement on the base frame; (ii) a screw rotatably supported on the base frame in meshing engagement with the sliding member such that rotation of the screw drives the linear sliding movement of the sliding member on the base frame; (iii) a connecting link pivotally coupled at a first end on the sliding member and pivotally coupled at a second end on the shoulder frame; and (iv) a first shoulder motor supported on the base frame to drive rotation of the screw and in turn drive movement of the shoulder frame relative to the base frame about the first shoulder axis.

The device may further comprise: (i) a connecting link supported on the shoulder frame for pivotal movement about a linkage axis oriented parallel to and spaced apart from the second shoulder axis, the connecting link extending radially outward from the linkage axis to a distal end of the connecting link; (ii) a guide arm extending in a longitudinal direction of the upper arm frame between a first end pivotally coupled to the shoulder frame at the second shoulder axis; (iii) a sliding member fixed onto the upper arm frame, the sliding member being (a) supported for sliding movement along the guide arm in the longitudinal direction of the upper arm frame and (b) pivotally coupled to the distal end of the connecting link; (iv) a second shoulder motor supported on the shoulder frame to drive pivotal movement of the connecting link and in turn drive pivotal movement of the upper arm frame relative to the shoulder frame about the second shoulder axis; (v) whereby the upper arm frame is displaced longitudinally along the guide arm as the guide arm and the upper arm frame are pivoted about the second should axis.

The device may further comprise: (i) a spur gear fixed immovably onto the connecting link at the linkage axis; and (ii) a worm gear rotatably supported on the shoulder frame in meshing engagement with the spur gear to drive pivotal movement of the spur gear and the connecting link connected thereto; (iii) the second shoulder motor driving rotation of the worm gear to in turn drive movement of the upper arm frame relative to the shoulder frame about the second shoulder axis.

The upper arm frame may be adjustable in length, whereby adjusting a length of the upper arm frame varies a distance between the second shoulder axis and the upright elbow axis.

The device may further include an elbow motor operatively connected between the lower arm frame and the upper arm frame to assist in driving movement of the lower arm frame relative to the upper arm frame about the upright elbow axis, in which the elbow motor has a rotary output that is coaxial with the elbow axis. The elbow axis may be vertically oriented in a neutral position when the upper arm frame extends generally horizontally between the second shoulder axis and the elbow axis, in which the elbow axis is moveable away from the vertically oriented neutral position together with pivotal movement of the upper arm frame about the second shoulder axis relative to the shoulder frame. The device may be further arranged such that the upper arm frame includes two first connecting arms, and the lower arm frame includes two second connecting arms pivotally coupled to the two first connecting arms respectively to define two pivot connections, in which the pivot connections are spaced apart along the elbow axis to define an arm receiving region between the pivot connections that receives the arm of the user therethrough.

The lower arm frame may comprise an annular frame member oriented concentrically with the longitudinal axis of the lower arm frame and receiving the arm of the user therethrough, in which the wrist frame is supported on the annular frame member for movement about the annular frame member relative to the lower arm frame.

The device may further comprise: (i) a row of gear teeth on the wrist frame extending circumferentially about at least a portion of the annular frame member of the lower arm frame; (ii) a spur gear supported on the lower arm frame in meshing engagement with the row of gear teeth; and (iii) a lower arm motor supported on the lower arm frame to drive rotation of the spur gear and in turn drive movement of the wrist frame relative to the lower arm frame about the longitudinal axis of the lower arm frame.

The device may further comprise a wrist motor operatively connected between the handle frame and the wrist frame to assist in driving movement of the handle frame relative to the wrist frame about the wrist axis, in which the wrist motor has a rotary output that is coaxial with the wrist axis.

### BRIEF DESCRIPTION OF THE DRAWINGS

One embodiment of the invention will now be described in conjunction with the accompanying drawings in which:

FIG. 1 is a perspective view of the exoskeletal rehabilitation device;

FIGS. 2 through 6 are further perspective views of the device in various states of pivotal movement of the shoulder frame relative to the base frame corresponding to flexion and extension of the upper arm of the user;

FIG. 7 is a perspective view of the device in which the upper arm frame is pivoted relative to the shoulder frame corresponding to abduction and adduction of the upper arm portion of the user;

FIGS. 8 and 9 are perspective views of the device in various states of pivotal movement of the lower arm frame relative to the upper arm frame corresponding to flexion and extension of the lower arm of the user;

FIGS. 10 and 11 are perspective views of the device in various states of pivotal movement of the handle frame relative to the wrist frame corresponding to flexion and extension of the hand relative to the lower arm of the user; and

FIG. 12 is a perspective view of the device in which the wrist frame is pivoted about the longitudinal axis of the lower arm frame relative to the position of the wrist frame in FIG. 11, corresponding to pronation and supination of the lower arm portion of the user.

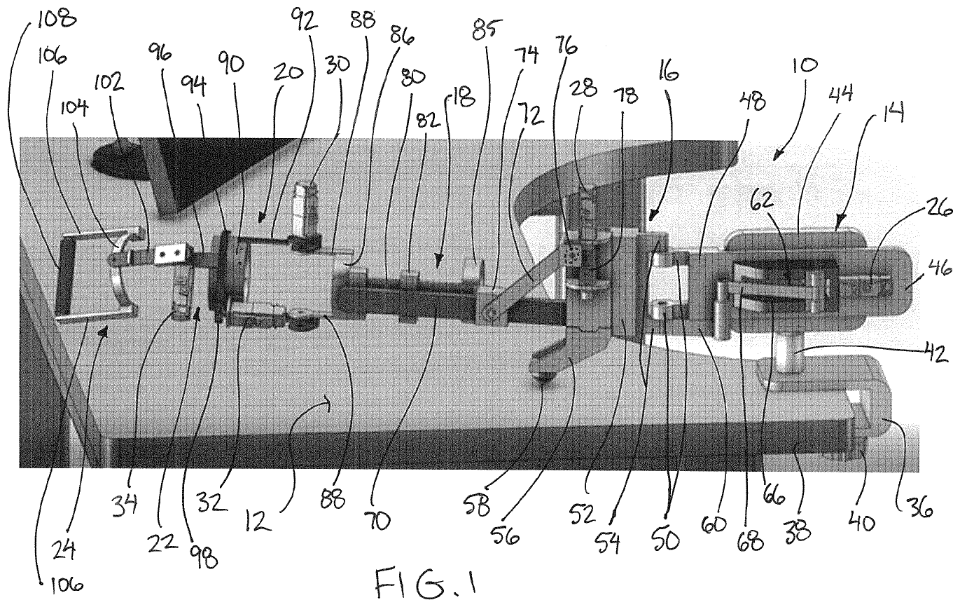

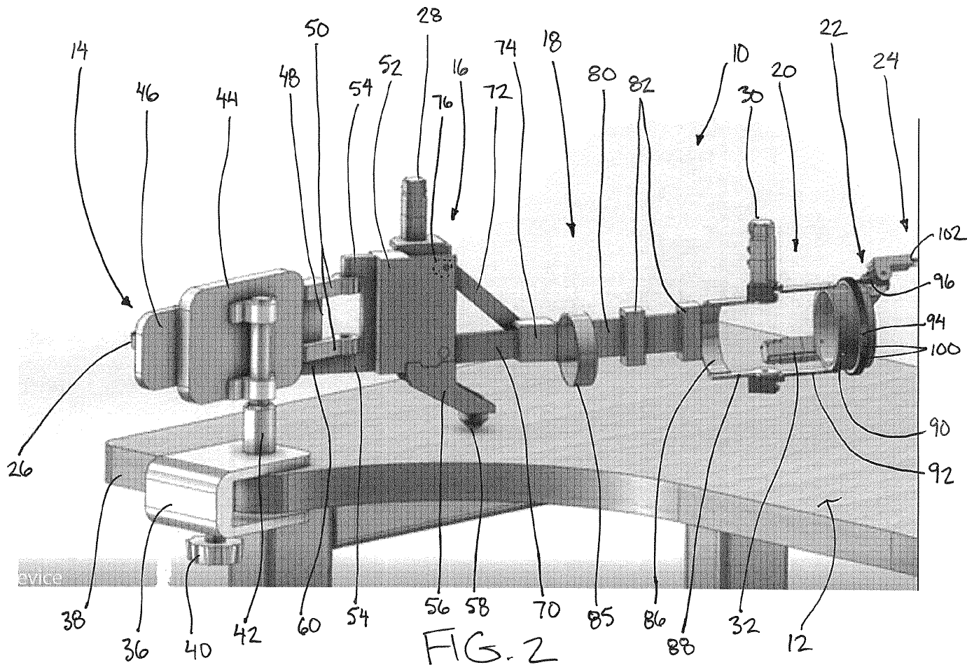

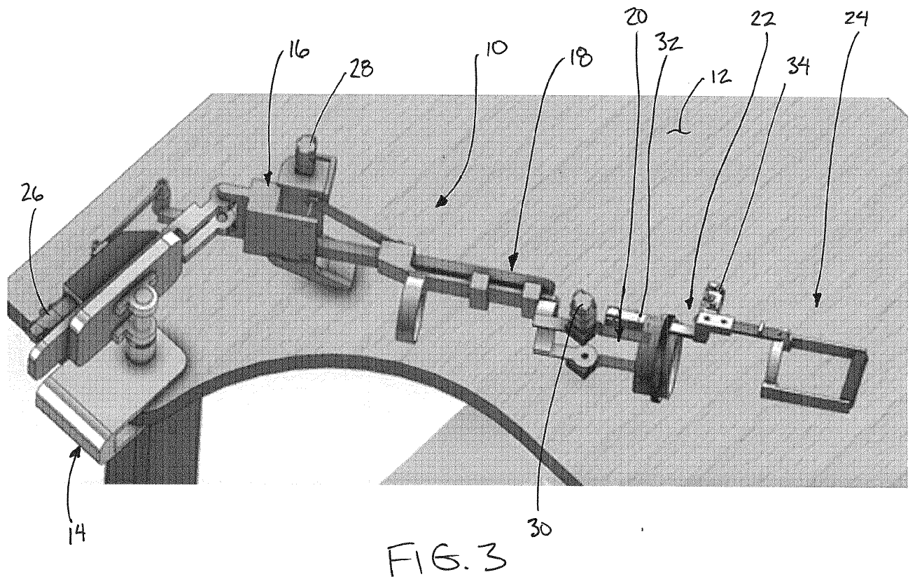

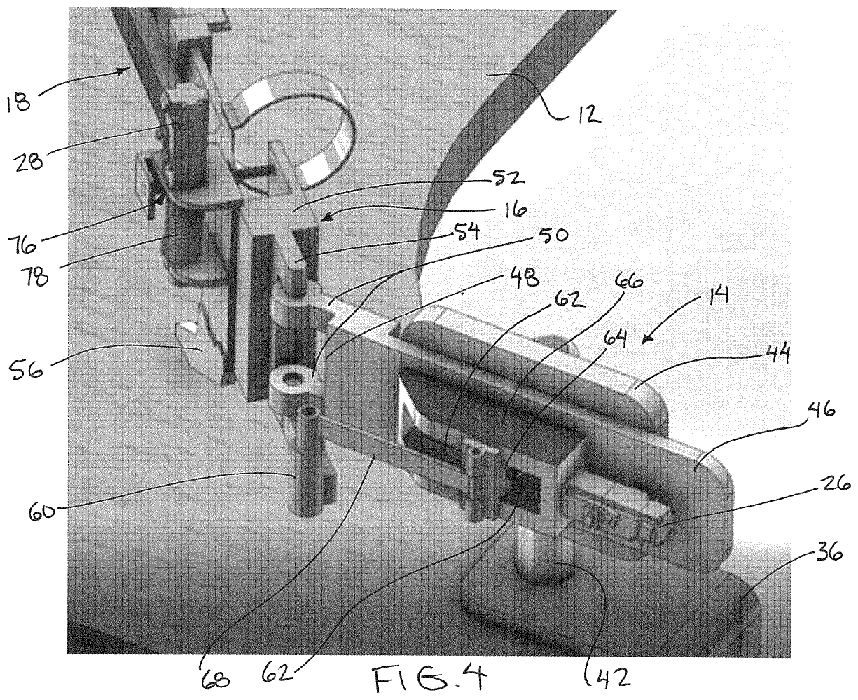

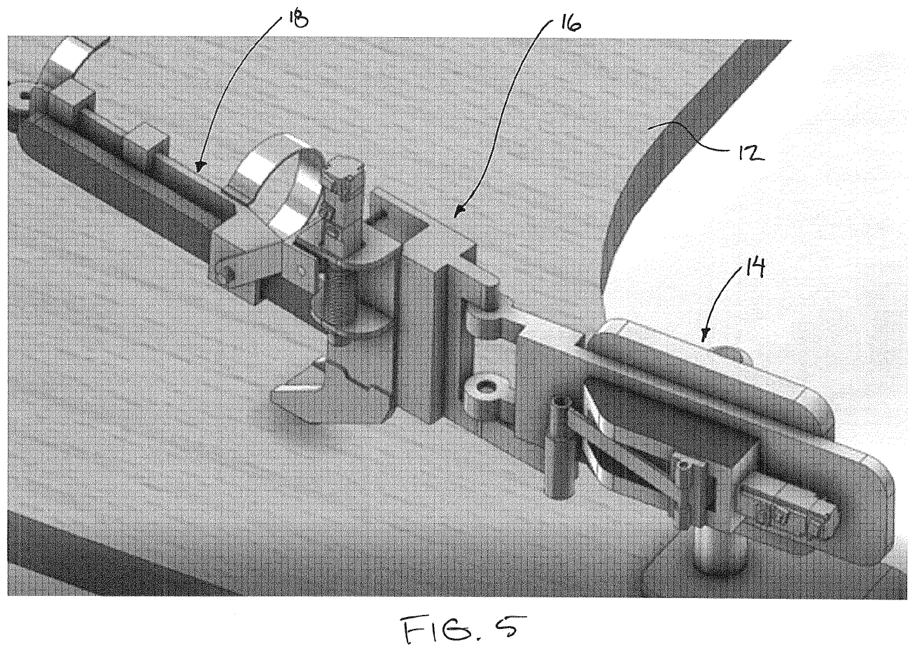

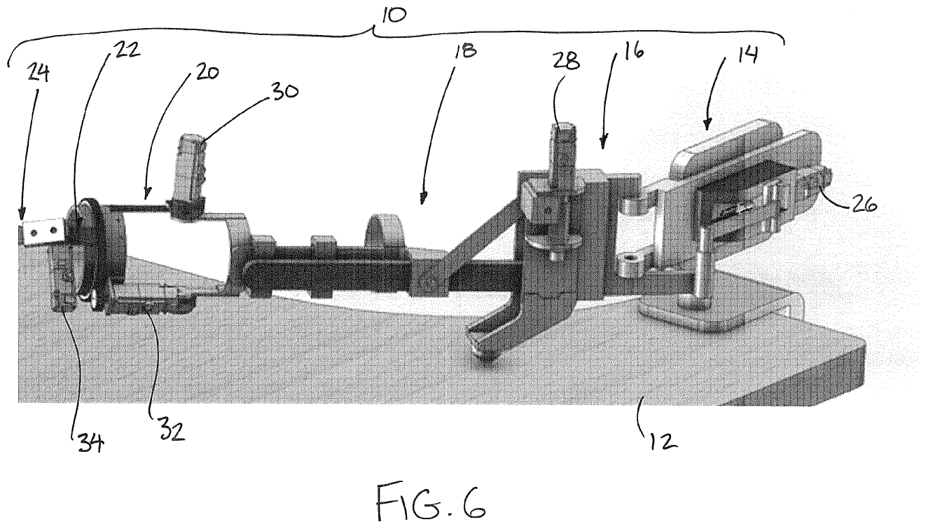

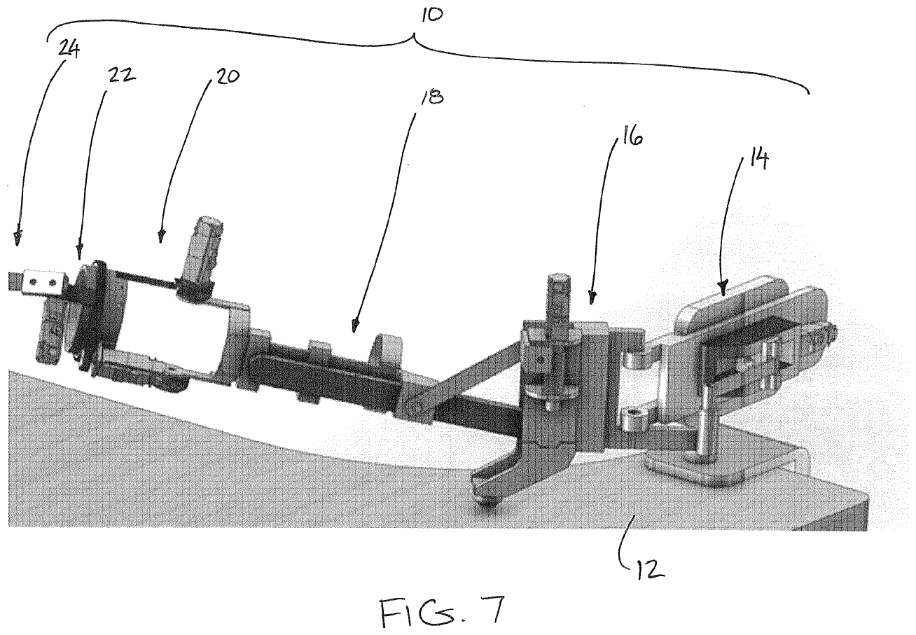

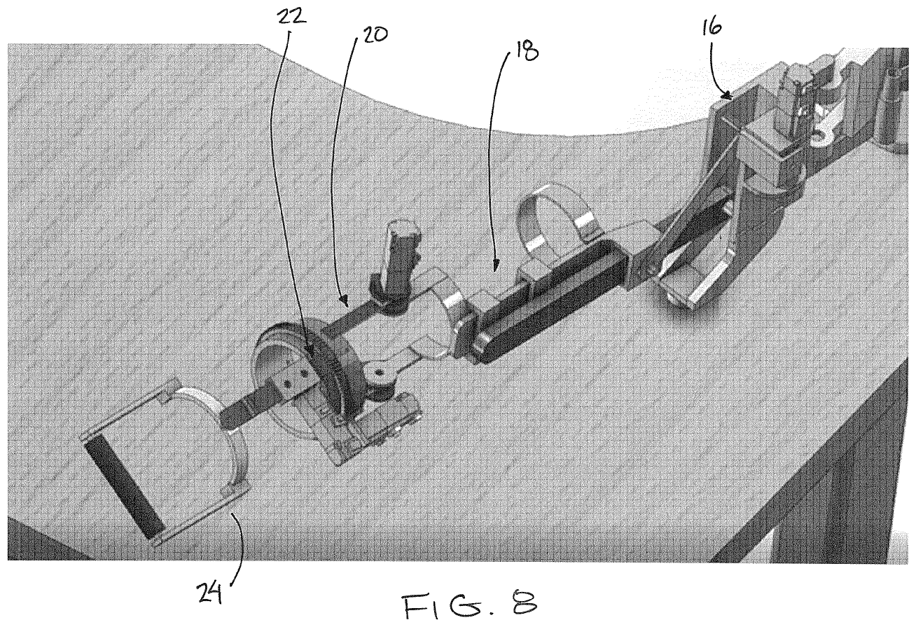

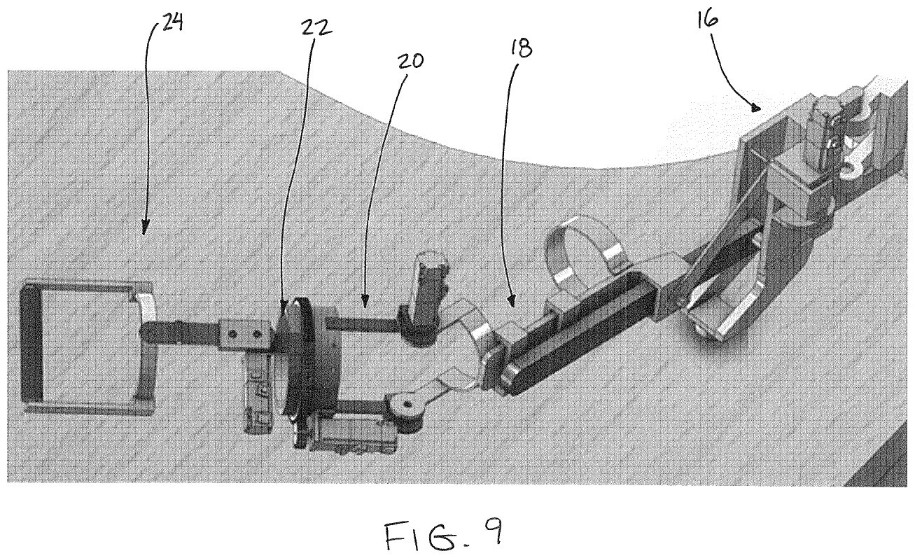

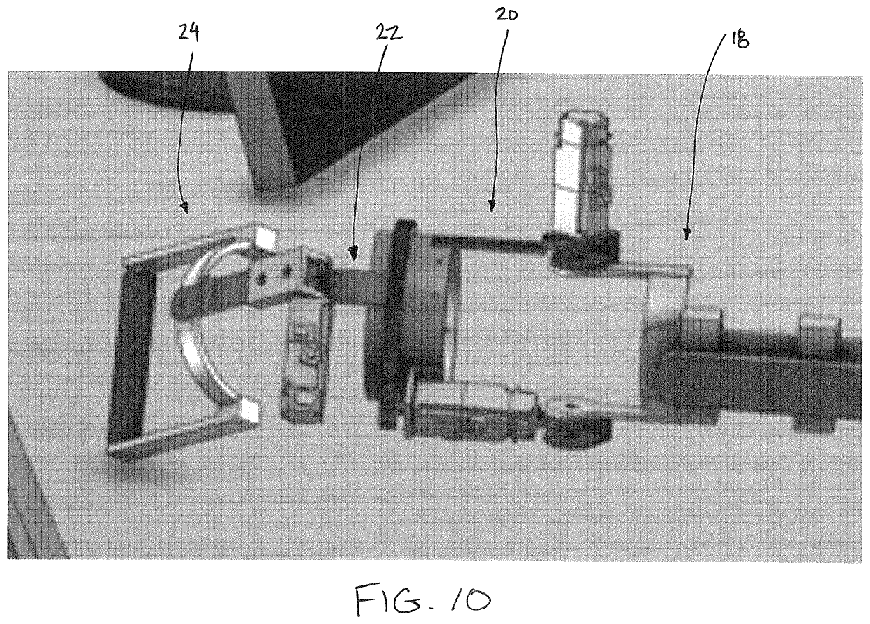

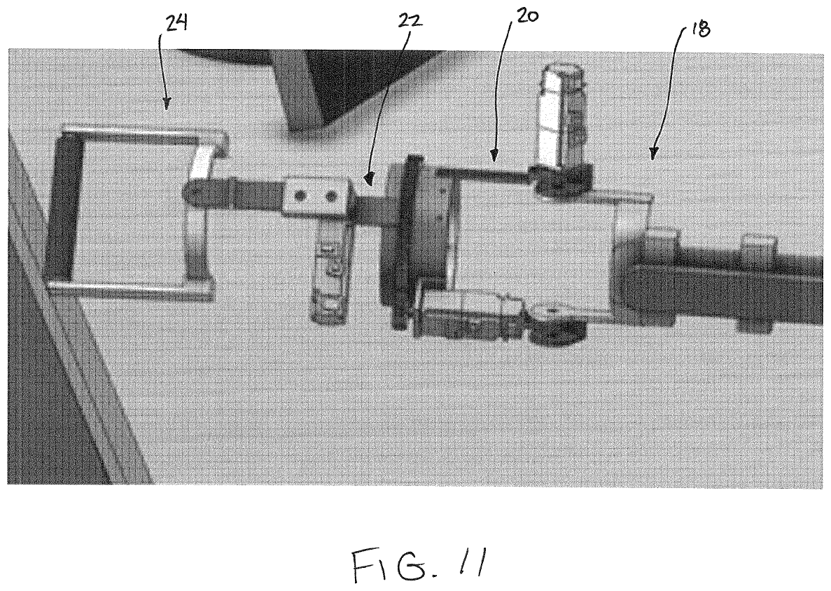

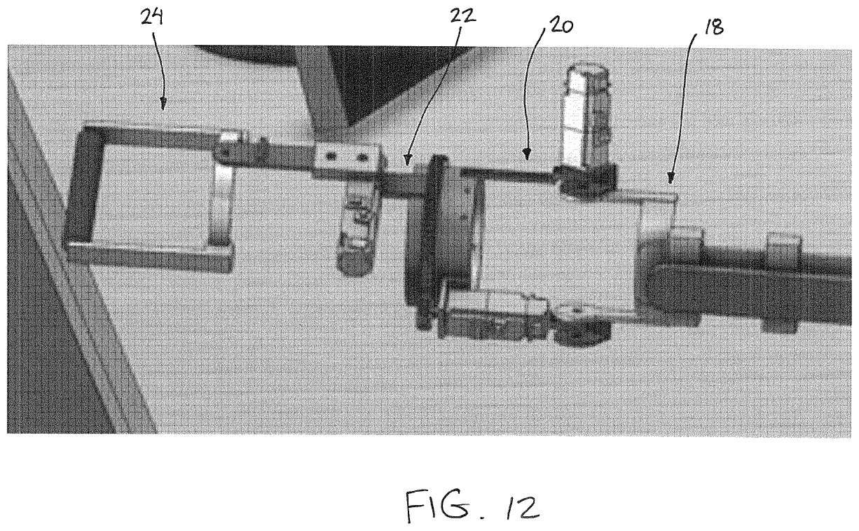

In the drawings, the same characters of reference indicate corresponding parts in the different figures.

### DETAILED DESCRIPTION

Referring to the accompanying figures, there is illustrated an exoskeletal upper limb rehabilitation device generally indicated by reference numeral 10. The device 10 is particularly suited for supporting a hand, a lower arm portion, and an upper arm portion of an arm of a user relative to a supporting surface 12 for rehabilitating the arm of the user.

The overall device 10 is formed of six frame portions connected in series to support the arm of the user while providing 5 degrees of freedom. More particularly, the device generally includes (i) a base frame 14 which is arranged to be mounted in fixed relation to the supporting surface 12, (ii) a shoulder frame 16 coupled to the base frame 14 for pivotal movement relative to the base frame about a first shoulder axis, (iii) an upper arm frame 18 pivotally coupled to the shoulder frame or movement relative to the shoulder frame about a second shoulder axis oriented transversely to the first shoulder axis, (iv) a lower frame 20 pivotally coupled to the upper arm frame 18 for movement relative to the upper arm frame about an upright elbow axis, (v) a wrist frame 22 pivotally coupled to the lower arm frame for pivotal movement about a longitudinal axis of the lower arm frame, and (vi) a handle frame 24 pivotally coupled to the lower arm frame for movement relative to the lower arm frame about a wrist axis.

The pivotal movement of the shoulder frame 16 relative to the base frame 14 about the first shoulder axis is intended to correspond with flexion and extension of the upper arm portion of the arm of the user. A first shoulder motor 26 is operatively connected between the shoulder frame 16 and the base frame 14 to assist in controlling movement therebetween and support the arm of the user during flexion and extension of the upper arm portion of the user.

The pivotal movement of the upper arm frame 18 relative to the shoulder frame 16 about the second shoulder axis is intended to correspond with abduction and adduction of the upper arm portion of the arm of the user. A second shoulder motor 28 is operatively connected between the upper arm frame and the shoulder frame to assist in controlling movement therebetween and support the arm of the user during the abduction and adduction of the upper arm of the user.

The pivotal movement of the lower arm frame 20 relative to the upper arm frame 18 about the upright elbow axis is intended to correspond with flexion and extension of the lower arm portion of the user relative to the upper arm portion of the user. An elbow motor 30 is operatively connected between the lower arm frame 20 and the upper arm frame 18 to assist in controlling movement therebetween and support the arm of the user during the flexion and extension of the lower arm portion relative to the upper arm portion of the user.

The pivotal movement of the wrist frame 22 relative to the lower arm frame 20 about the longitudinal axis of the lower arm frame is intended to correspond with pronation and supination of the lower arm portion of the user. A lower arm motor 32 is operatively connected between the wrist frame 22 and the lower arm frame 20 to assist in controlling movement therebetween and support the arm of the user during pronation and supination of the lower arm portion of the user relative to the upper arm portion of the user.

The pivotal movement of the handle frame 24 relative to the wrist frame 22 about the wrist axis is intended to correspond with flexion and extension of the hand of the user relative to the lower arm portion of the user. A wrist motor 34 is operatively connected between the handle frame 24 and the wrist frame 22 to assist in controlling movement therebetween and support the arm of the user during flexion and extension of the hand of the user relative to the lower arm portion of the user.

The base frame 14 includes a lower mounting portion in the form of a clamp member 36 which is arranged to be secured fixed and immovably to the supporting surface 12. In the illustrated example, the supporting surface 12 comprises the upper surface of a supporting body such as a table having a tabletop with a horizontal upper panel that terminates at a table edge 38. The clamp member includes a U-shaped body arranged to receive the table edge inserted into the open side of the clamp member. The upper portion of the clamp member 36 forms a fixed upper jaw of a clamping assembly. A screw body 40 is threaded into the lower portion of the clamp member 36 so as to be adjustable in height relative to the upper portion of the clamp member by rotating the screw body about a longitudinal axis thereof. Accordingly, the upper end of the screw body defines a movable lower jaw which can be displaced towards and away from the upper jaw for clamping against opposing upper and lower surfaces of the tabletop.

The base frame 14 further includes a telescoping post 42 extending upwardly from the upper portion of the clamp member 36 such that the upper end of the telescoping post 42 can be adjusted in height relative to the clamp member. The telescoping post includes plural post sections which mate with one another to enable extension and retraction of the post to adjust the height. Once the height has been selected according to preference of the height of the user, the telescoping post sections can be fixed at a prescribed length using a suitable clamping structure, transverse pin, or set screw configuration for example, which secure the post sections non-rotatably and immovable relative to one another. In yet further instances, the telescoping post may simply be interchanged with different posts of different length for varying the height of the top end of the post upon which the remainder of the base frame is supported.

The base frame 14 further includes a main upper body portion 44 in the form of an upright plate member fixed alongside an upper portion of the telescoping post 42. The main upper body portion 44 in the illustrated embodiment comprises a flat rigid plate which is vertically oriented and which is supported non-rotatably relative to the clamp member 36. The base frame further includes a longitudinal body portion 46 in the form of a second plate member mounted alongside the main body portion. The longitudinal body portion is elongate in a horizontal direction which protrudes forwardly from the post 42 to a forward end 48 of the base frame that supports the shoulder frame 16 thereon. More particularly, the forward end 48 comprises two connecting arms 50 which extend forward in the longitudinal direction beyond the end of the longitudinal body portion 46 at vertically spaced positions in alignment with top and bottom edges of the longitudinal body portion 46 respectively. A vertically oriented mounting aperture is located at the forward end of each connecting arm 50 to define respective portions of a hinge structure coupling the shoulder frame 16 relative to the base frame whereby the vertical mounting apertures at the forward ends of the connecting arms 50 define the first shoulder axis so as to be vertical in orientation.

The shoulder frame 16 includes a main body portion 52 comprised of two parallel plates define laterally opposing side surfaces of the main body portion. A pair of connecting arms 54 extend rearwardly from the rear end of the main body 52 for coupling to respective ones of the two connecting arms 50 of the base frame 14. Each of the connecting arms 54 of the shoulder frame 16 supports a respective pivot shaft thereon in operative connection with the vertical mounting apertures in the connecting arms 50 of the base frame to define the pivotal connection between the base frame and the shoulder frame about the vertical first shoulder axis.

A support frame 56 is releasably mounted to the bottom end of the main body portion 52 of the shoulder frame 16 to extend downwardly from the main body portion to a bottom end of the support frame 56 which is intended to engage the supporting surface 12 upon which the base frame 14 is clamped. The support frame similarly comprises two parallel plates extending downward from respective plates of the main body portion 52 of the shoulder frame. A suitable ball 58 is rotatably supported between the two plates of the support frame 56 at the bottom end thereof. The ball 58 is supported within a respective socket for rolling movement in any direction relative to the support frame such that the shoulder frame is supported for rolling contact along the upper supporting surface 12 of the tabletop as the shoulder frame 16 is pivoted relative to the base frame about the vertical first shoulder axis.

The support frame 56 can be released and interchanged with different support frames having different heights corresponding to the selected height of the telescoping post 42 of the base frame. Alternatively, the mounting of the ball 58 at the bottom end of the support frame 56 can be adjustable in height relative to the plates forming the support frame. In either instance, the rolling contact at the bottom of the ball can be adjusted in height relative to the shoulder frame 16 so as to enable the rolling contact of the ball to be aligned in a common horizontal plane with the fixed upper jaw of the clamp member of the base frame 14 regardless of the selected height of the telescoping post 42.

The shoulder frame 16 further includes a crank arm 60 extending rearwardly from the main body portion 52 beyond the connecting arms 54 that define the vertical first shoulder axis. The rear end of the crank arm 60 is thus positioned generally rearwardly of the first shoulder axis for operative connection to the first shoulder motor 26 to control pivotal movement of the shoulder frame 16 relative to the base frame as described in the following.

The first shoulder motor 26 is supported on the longitudinal body portion 46 of the base frame 14 at the rear of the base frame so as to be diametrically opposite from the first shoulder axis relative to the vertical telescoping post 42. The first shoulder motor includes a rotary output which is horizontally oriented and protrudes forwardly in connection with a screw 62 supported for rotation about a longitudinal axis of the screw which is oriented in the longitudinal direction of the body portion 46. A sliding member 64 is supported on the body portion 46 for linear sliding movement within a respective track 66 oriented in a longitudinal direction of the body portion 46 so as to be parallel to the axis of rotation of the screw 62. The sliding member 64 includes an internally threaded bore which meshes with the screw 62 such that rotation of the screw drives the sliding member longitudinally along the track 66 towards and away from the vertical first shoulder axis.

A connecting link 68 is pivoted about a vertical axis at a rear end on the sliding member 64 and is pivoted about a vertical axis at a forward end on the crank arm 60 at a location that is generally rearward of the first shoulder axis at a starting orientation when the upper arm frame extends generally forwardly from the base frame. Rotating the first shoulder motor 26 in a first direction of rotation drives longitudinal sliding movement of the sliding member 64 in a first direction which acts on the crank arm to pivot the shoulder frame in a first direction about the first shoulder axis. Alternatively, rotating the first shoulder motor 26 in the opposing second direction of rotation drives longitudinal sliding movement of the sliding member in an opposing second direction which acts on the crank arm to pivot the shoulder frame in a second direction about the first shoulder axis.

The upper arm frame 18 is supported relative to the shoulder frame by an elongate guide arm 70 which is hinged at a rear end between the side plates of the main body 52 of the shoulder frame 16 for pivotal movement about a horizontal second shoulder axis at the rear end of the guide arm 70. In an initial starting position of the device, the guide arm extends generally horizontally forward and defines a longitudinal direction that the upper arm frame extends from the rear end to the forward end thereof.

A connecting link 72 is also provided which is pivotally coupled at the rear end thereof between the side plates of the main body 52 of the shoulder frame 16 for pivotal movement about a horizontal linkage axis which is parallel and spaced above the second shoulder axis. In the starting position, the connecting link extends downwardly and forwardly from the rear end of the connecting link that is pivotally coupled on the shoulder frame to a forward end of the connecting link that is pivotally coupled on a sliding member 74 that forms part of the upper arm frame 18 and which is supported for longitudinal sliding movement along the guide arm. More particularly, the sliding member 74 is a sleeve or collar mounted on the guide arm for sliding movement in the longitudinal direction of the upper arm frame. In this manner, upward pivoting of the connecting link 72 from the starting position causes the sliding member 74 to be slidably displaced forwardly along the guide arm while the guide arm is pivoted upwardly from the horizontal starting position.

A spur gear 76 is mounted at the linkage axis at the rear of the connecting link 72 in fixed and immovable relationship relative to the connecting link, for example by being keyed to a common shaft rotatably supported between the side plates of the main body of the shoulder frame 16 such that the spur gear 76 and the connecting link 72 pivot together about the linkage axis relative to the shoulder frame. The second shoulder motor 28 is mounted on the shoulder frame and includes a worm gear 78 supported on the rotary output of the motor for rotation about a longitudinal and vertical axis of the worm gear. The worm gear 78 is supported in meshing engagement with the spur gear 76 such that rotating the motor into opposing directions results in the worm gear and the corresponding spur gear being rotated into opposing directions which in turn displaces the connecting link upwardly to lift the guide arm from the starting position or downwardly to lower and return the guide arm to the starting position.

The upper arm frame 18 further includes a main arm 80 which is elongated in the longitudinal sliding direction of the upper arm frame and extends alongside the guide arm 70. The main arm 80 is supported by two mounting collars 82 at longitudinally spaced positions along the guide arm. The mounting collars 82 are fixed onto the guide arm 70 while the main arm 80 is longitudinally slidable through the collars to provide sliding support to the main arm at longitudinally spaced positions along the main arm. Furthermore, the main arm 80 is coupled in fixed relation to the sliding member 74 so as to permit the main arm 80 to be longitudinally slidable with the sliding member 74 relative to the guide arm 70 as the guide arm is pivoted by the motor 28 acting on the connecting link 72.

The upper arm frame 18 further includes an annular support band 85 forming a hoop surrounding a central axis that is oriented parallel to the longitudinal direction of the upper arm frame and having a suitable diameter for receiving the upper arm of the user extending therethrough. The annular support band 85 can be adjustable in circumference, or interchanged with different bands of different diameter to provide suitable support to a variety of different users.

The upper arm frame 18 also includes an outer frame member 86 in the form of a rigid body that extends in a circumferential direction about the longitudinal axis of the upper arm frame through part of the circumference to be generally semicircular in shape. The outer frame member 86 is mounted centrally on the forward end of the main arm 80 and partly receives the arm of the user extending therethrough in use.

The outer frame member 86 can be mounted onto the main arm 80 so as to be adjustable in position in the longitudinal direction of the main arm which acts to adjust an overall length of the upper arm frame 18. More particularly, the longitudinal spacing between the second shoulder axis and the elbow axis is adjusted when the position of the outer frame member 86 is longitudinally adjusted relative to the main arm 80. When positioned at a selected length of the upper arm frame, the outer frame member 86 can be fixed immovably relative to the main arm 80 using various means connected therebetween.

The outer frame member 86 provides support for a pair of connecting arms 88 that are mounted at the top and bottom ends of the outer frame member 86 to extend forwardly from the outer frame member in the longitudinal direction of the upper arm frame. The connecting arms 88 define pivotal connections at the forward end thereof which collectively define the elbow axis extending between the forward ends of the connecting arms 88 which is vertical in orientation when the longitudinal direction of the upper arm frame is horizontally oriented in the starting position. The vertical orientation of the elbow axis is displaced angularly away from vertical as the upper arm frame is pivoted upwardly about the second shoulder axis.

The lower arm frame 20 includes an annular frame member 90 forming the main body portion of the lower arm frame and which extends concentrically about a longitudinal axis of the lower arm frame. The annular frame member 90 as a diameter which is suitable for receiving the arm of the user extending therethrough. A pair of connecting arms 92 extend rearwardly from diametrically opposed top and bottom ends of the annular frame member 90 for connection to the pivots of the two connecting arms 88 of the upper arm frame respectively. In this manner, the annular frame member 90 of the lower arm frame is supported by the two connecting arms 92 for pivotal movement about the elbow axis.

The elbow motor 30 is mounted on one of the connecting arms 88 of the upper arm frame and includes a rotary output concentric with the elbow axis which is coupled to one of the connecting arms 92 of the lower arm frame. In this manner driving the rotary output of the elbow motor in opposing directions of rotation acts to pivot the lower arm frame relative to the upper arm frame in two opposing directions of rotation about the elbow axis.

The wrist frame includes an annular driven member 94 in the form of a collar which is concentrically mounted about the annular frame member 90 of the lower arm frame while being supported to rotate relative to the lower arm frame about the longitudinal axis that is concentric with the annular frame member of the lower arm frame. The wrist frame further includes a longitudinal frame member 96 which is fixedly mounted on the annular driven member 94 to project axially forwardly beyond the annular frame member 90 at the forward end of the lower arm frame. A pivot at the forward end of the longitudinal frame member defines the wrist axis that pivotally supports the handle frame thereon in which the wrist axis is tangential to the annular driven member 94.

The lower arm motor 32 is mounted fixedly on the annular frame member 90 of the lower arm frame and includes a rotary output that is parallel to the longitudinal axis of the lower arm frame. A spur gear 98 is supported on the rotary output of the lower arm motor to be driven by the motor about an axis that is parallel to the longitudinal axis of the lower arm frame. A row of gear teeth 100 are provided to extend circumferentially along the annular driven member 94 in meshing engagement with corresponding teeth of the spur gear 98. In this manner, driving rotation of the spur gear into opposing directions of rotation using the lower arm motor 32 acts to drive rotation of the annular driven member 94 of the wrist frame in two opposing directions of rotation about the longitudinal axis of the lower arm frame.

Pivotal movement of the handle frame relative to the wrist frame is accomplished by locating the wrist motor 34 on the forward end of the longitudinal frame member 96 of the wrist frame such that the rotary output of the wrist motor is concentric with the wrist axis and is pivotally coupled to the handle frame at the pivot at the forward end of the longitudinal frame member. In this manner, driving rotation of the output of the motor in two opposing directions acts to pivot the handle frame in two opposing directions of rotation relative to the wrist frame about the wrist axis.

The handle frame 24 includes a longitudinal frame member 102 extending forward from the rear end of the handle frame. The rear end of the longitudinal frame member 102 is thus pivotally coupled to the forward end of the longitudinal frame member 96 of the wrist frame while being coupled to the output of the wrist motor so that the longitudinal frame member is pivoted with the handle frame relative to the wrist frame. An outer frame member 104 is fixed onto the forward end of the longitudinal frame member 102. The outer frame member 104 is an arc-shaped member that is semicircular about a central axis oriented parallel to a longitudinal axis of the handle frame as defined by the longitudinal frame member 102.

A pair of support arms 106 are mounted at opposing ends of the outer frame member 104 to extend longitudinally forward therefrom, parallel to the longitudinal axis of the handle frame. A handle member 108 is connected between the forward ends of the two support arms 106 perpendicularly to the longitudinal axis of the handle frame. The handle member 108 is located to be readily gripped in the closed first of a user when the wrist of the user is aligned approximately with the wrist axis in the longitudinal direction of the handle frame.

In use, the user inserts their arm through the annular support band 85 on the upper arm frame and through the annular frame member 90 of the lower arm frame, then grips the handle member 108 in their fist. The length of the upper arm frame is adjusted to correspond approximately to the length of the upper arm of the user between the shoulder axis and the elbow axis. The annular support band 85 can also be sized to comfortably support the arm of the user extending therethrough by matching the circumference of the band to the circumference about the upper arm of the user. When the user is seated at a leading edge of the supporting body 12 upon which the device 10 is mounted, the height of the base frame can also be adjusted along with the height of the rolling support of the shoulder frame relative to the horizontal second shoulder axis to align the device with the shoulder of the user.

The motors all have a rotary output and a compact design to assist in driving movement about each of the five defined axes of the device 10 respectively. A suitable controller may operate the motors to provide complete support to the arm of the user while the motors drive movement in a prescribed manner to guide the movement of the arm. Alternatively, the motors may be operated in response to various feedback to carry only part of the weight of the arm of the user based on the injury levels of users and to respond to user movement so that movement is guided by the user and the motors are operated to carry part of the load of the arm throughout the movement to assist the user guided movement. In addition, the motors can be controlled to correct the user movement according to the planned rehabilitation trajectory.

The adaptability and portability of the device 10 are compared with the most sold end-effector-based device (Icone® by Heaxel) and the most sold exoskeleton-based device (Armeo® Spring by Hocoma AG) as listed in Table 1 below. The size and adjustable ranges of rehabilitation devices are found from device specifications in the respective company websites.

TABLE 1
Comparison of the Device 10 with other devices.

| | | | Armeo@ |
|---|---|---|---|
| | Rehabilitation | icone@ by | Spring by |
| | Device 10 | Heaxel | Hocoma AG |
| Size (Length × | 1.2 m × 0.3 m × | 1.1 m × 0.6 m × | 1.2 m × 1.1 m × |
| Width × | 0.5 m | 0.6 m | 1.6 m |
| Height) | | | |
| Mechanism of | Screw of | Guide and | Guide and |
| fixing arm | clamping | Slider | Slider |
| | mechanism | | |
| Adjustable | 0.60 m | 0 m | 0.50 m |
| range for | | | |
| height | | | |
| Adjustable | 0.50 m | 0 m | 0.30 m |
| range for upper | | | |
| arm | | | |
| Adjustable | 0.30 m | 0 m | 0.10 m |
| range for lower | | | |
| arm | | | |
| Can the | Yes | No | No |
| rehabilitation | | | |
| arm be easily | | | |
| assembled? | | | |
| Location of | Home; Hospital | Home; Hospital | Hospital |
| rehabilitation | | | |
| exercises | | | |

Based on the comparison in Table 1, the device 10 according to the present invention shows the best performance in both adjustability and portability. The device has 5 DOF to meet different joint movements accurately. The device uses a telescopic rod in the base frame to adjust the device height, which reduces the device size and increases the adjustable height range. The rolling support of the shoulder frame that rolls along the supporting surface supports most of the arm weight for the device balance in operations. In addition, the device can be uninstalled and installed easily to be moved from one location to another.

Since various modifications can be made in the invention as herein above described, and many apparently widely different embodiments of same made, it is intended that all matter contained in the accompanying specification shall be interpreted as illustrative only and not in a limiting sense.

1. An exoskeletal rehabilitation device arranged to support a hand, a lower arm portion, and an upper arm portion of an arm of a user relative to a supporting surface for rehabilitating the arm of the user, the device comprising:
a base frame arranged to be mounted in fixed relation to the supporting surface;
a shoulder frame coupled to the base frame for pivotal movement about a first shoulder axis;
an upper arm frame coupled to the shoulder frame for pivotal movement about a second shoulder axis transverse to the first shoulder axis relative to the shoulder frame, the upper arm frame being arranged to extend alongside the upper arm portion of the arm of the user when the arm of the user is supported on the device such that (i) pivotal movement of the upper arm frame about the second shoulder axis corresponds to abduction and adduction of the upper arm portion of the arm of the user, and (ii) pivotal movement of the shoulder frame portion about the first shoulder axis corresponds to flexion and extension of the upper arm portion of the arm of the user;
a lower arm frame coupled to the upper arm frame for pivotal movement about an upright elbow axis relative to the upper arm frame, the lower arm frame being arranged to extend alongside the lower arm portion of the arm of the user when the arm of the user is supported on the device such that pivotal movement of the lower arm frame about the upright elbow axis corresponds to flexion and extension of the lower arm portion of the arm of the user;
a wrist frame coupled to the lower arm frame for pivotal movement about a longitudinal axis of the lower arm frame relative to the lower arm frame such that pivotal movement of the wrist frame about the longitudinal axis corresponds to pronation and supination of the lower arm portion of the arm of the user; and
a handle frame coupled to the lower arm frame for pivotal movement about a wrist axis relative to the wrist frame, the handle frame defining a handle thereon arranged to be gripped in the hand of the user when the arm of the user is supported on the device such that pivotal movement of the handle frame about the wrist axis relative to the wrist frame corresponds to flexion and extension of the hand of the user.

2. The device according to claim 1 further comprising the base frame including a mounting portion arranged to be secured to the supporting surface at a location in proximity to the first and second shoulder axes.

3. The device according to either one of claim 1 or 2 in combination with a counter defining the supporting surface thereon, the base frame being supported in fixed and immovable relationship to the counter.

4. The device according to any one of claims 1 through 3 wherein the base frame includes a clamp member arranged to be clamped onto an object defining the supporting surface thereon, the clamp member being located in proximity to the first and second shoulder axes of the device.

5. The device according to claim 4 wherein the base frame is adjustable in height relative to the clamp member.

6. The device according to any one of claims 1 through 5 further comprising (i) a mounting portion on the base frame arranged to secure the base frame fixed and immovably to the supporting surface, and (ii) a secondary supporting portion on the shoulder frame arranged to engage the supporting surface and support the shoulder frame for movement relative to the supporting surface while the shoulder frame is displaced about the first shoulder axis relative to the base frame.

7. The device according to claim 6 wherein the secondary supporting portion includes a roller arranged to be supported in rolling contact with the supporting surface while the shoulder frame is displaced about the first shoulder axis relative to the base frame.

8. The device according to any one of claims 1 through 7 further comprising:
a first shoulder motor operatively connected between the shoulder frame and the base frame to assist in driving movement of the shoulder frame relative to the base frame about the first shoulder axis;
a second shoulder motor operatively connected between the upper arm frame and the shoulder frame to assist in driving movement of the upper arm frame relative to the shoulder frame about the second shoulder axis;
an elbow motor operatively connected between the lower arm frame and the upper arm frame to assist in driving movement of the lower arm frame relative to the upper arm frame about the upright elbow axis;
a lower arm motor operatively connected between the wrist frame and the lower arm frame to assist in driving movement of the wrist frame relative to the lower arm frame about the longitudinal axis of the lower arm frame; and
a wrist motor operatively connected between the handle frame and the wrist frame to assist in driving movement of the handle frame relative to the wrist frame about the wrist axis.

9. The device according to claim 8 wherein each of the motors comprises a rotary driven motor having a rotary output.

10. The device according to any one of claims 1 through 9 further comprising:
a sliding member supported for linear sliding movement on the base frame;
a screw rotatably supported on the base frame in meshing engagement with the sliding member such that rotation of the screw drives the linear sliding movement of the sliding member on the base frame;
a connecting link pivotally coupled at a first end on the sliding member and pivotally coupled at a second end on the shoulder frame; and
a first shoulder motor supported on the base frame to drive rotation of the screw and in turn drive movement of the shoulder frame relative to the base frame about the first shoulder axis.

11. The device according to any one of claims 1 through 10 further comprising:
a connecting link supported on the shoulder frame for pivotal movement about a linkage axis oriented parallel to and spaced apart from the second shoulder axis, the connecting link extending radially outward from the linkage axis to a distal end of the connecting link;
a guide arm extending in a longitudinal direction of the upper arm frame between a first end pivotally coupled to the shoulder frame at the second shoulder axis;
a sliding member fixed onto the upper arm frame, the sliding member being (i) supported for sliding movement along the guide arm in the longitudinal direction of the upper arm frame and (ii) pivotally coupled to the distal end of the connecting link;
a second shoulder motor supported on the shoulder frame to drive pivotal movement of the connecting link and in turn drive pivotal movement of the upper arm frame relative to the shoulder frame about the second shoulder axis;
whereby the upper arm frame is displaced longitudinally along the guide arm as the guide arm and the upper arm frame are pivoted about the second should axis.

12. The device according to claim 11 further comprising:
a spur gear fixed immovably onto the connecting link at the linkage axis; and
a worm gear rotatably supported on the shoulder frame in meshing engagement with the spur gear to drive pivotal movement of the spur gear and the connecting link connected thereto;
the second shoulder motor driving rotation of the worm gear to in turn drive movement of the upper arm frame relative to the shoulder frame about the second shoulder axis.

13. The device according to any one of claims 1 through 12 wherein the upper arm frame is adjustable in length, whereby adjusting a length of the upper arm frame varies a distance between the second shoulder axis and the upright elbow axis.

14. The device according to any one of claims 1 through 13 further comprising an elbow motor operatively connected between the lower arm frame and the upper arm frame to assist in driving movement of the lower arm frame relative to the upper arm frame about the upright elbow axis, the elbow motor having a rotary output that is coaxial with the elbow axis.

15. The device according to claim 14 wherein the elbow axis is vertically oriented in a neutral position when the upper arm frame extends generally horizontally between the second shoulder axis and the elbow axis, the elbow axis being moveable away from the vertically oriented neutral position together with pivotal movement of the upper arm frame about the second shoulder axis relative to the shoulder frame.

16. The device according to claim 15 wherein the upper arm frame includes two first connecting arms, and the lower arm frame includes two second connecting arms pivotally coupled to the two first connecting arms respectively to define two pivot connections, the pivot connections being spaced apart along the elbow axis to define an arm receiving region between the pivot connections that receives the arm of the user therethrough.

17. The device according to any one of claims 1 through 16 wherein the lower arm frame comprises an annular frame member oriented concentrically with the longitudinal axis of the lower arm frame and receiving the arm of the user therethrough, the wrist frame being supported on the annular frame member for movement about the annular frame member relative to the lower arm frame.

18. The device according to claim 17 further comprising:
a row of gear teeth on the wrist frame extending circumferentially about at least a portion of the annular frame member of the lower arm frame;
a spur gear supported on the lower arm frame in meshing engagement with the row of gear teeth; and
a lower arm motor supported on the lower arm frame to drive rotation of the spur gear and in turn drive movement of the wrist frame relative to the lower arm frame about the longitudinal axis of the lower arm frame.

19. The device according to any one of claims 1 through 18 further comprising a wrist motor operatively connected between the handle frame and the wrist frame to assist in driving movement of the handle frame relative to the wrist frame about the wrist axis, the wrist motor having a rotary output that is coaxial with the wrist axis.
